(19) United States
(12) Patent Application Publication
(10) Pub. No.: US 2025/0154057 A1
(43) Pub. Date: May 15, 2025

(54) METHODS FOR CARBON SEQUESTRATION AND MAKING MAGNESIUM-BASED CEMENT

(71) Applicant: ZS2 Technologies Ltd., Calgary (CA)

(72) Inventors: Douglas Geoffrey BROWN, Calgary (CA); Parvaneh ROSHANKHAJEH, Calgary (CA); Robert John KING, Calgary (CA)

(21) Appl. No.: 18/956,045

(22) Filed: Nov. 22, 2024

Related U.S. Application Data
(63) Continuation of application No. PCT/CA2022/051155, filed on Jul. 27, 2022.
(60) Provisional application No. 63/347,002, filed on May 30, 2022.

(51) Int. Cl. C04B 9/06; B01D 53/62; B01D 53/81; C04B 9/20; C04B 111/00; C25B 1/20; C25B 1/22; C25B 1/50

(52) U.S. Cl. CPC C04B 9/06; B01D 53/62; B01D 53/81; C04B 9/20; C25B 1/20; C25B 1/22; C25B 1/50; B01D 2251/402; B01D 2251/604; B01D 2257/504; B01D 2258/0283; C04B 2111/00017

(57) ABSTRACT

A method for producing cement comprises: obtaining a first hydroxide; forming a first carbonate from the first hydroxide; forming a mixture by mixing the first carbonate, magnesium oxide and zeolite; and allowing the mixture to cure to thereby form cement.

### REFERENCE TO RELATED APPLICATIONS

This application is a continuation of PCT application No. PCT/CA2022/051155 having an international filing date of 27 Jul. 2022 which in turn claims priority from, and for the purposes of the United States the benefit under 35 USC 119 in relation to, U.S. patent application No. 63/347,002 filed 30 May 2022. All of the applications in this paragraph are hereby incorporated herein by reference.

### TECHNICAL FIELD

This invention relates to the field of carbon sequestration, and in particular methods and systems for carbon sequestration through making of magnesium-based cement.

### BACKGROUND

There is a general desire to reduce anthropogenic sources of carbon dioxide. Carbon dioxide is a prominent greenhouse gas that causes climate change. The global cement industry is a significant source of carbon dioxide, with the cement industry contributing an estimated 7% to anthropogenic sources of carbon dioxide and an estimated 23% by 2050.

Portland cement (the most common type of cement) is produced by first creating clinker. Portland cement is merely ground clinker with optional additives. Clinker is created by feeding raw materials to a kiln. A major constituent of the feed to the kiln is limestone (CaCO₃). A kiln is typically in the shape of a long cylinder. It is slanted such that the inlet side of the kiln is higher than the outlet side of the kiln, and configured to rotate to move material from its inlet to its outlet. At the outlet side of the kiln is a heat source. Because there is a heat source only on one side of the kiln, there is a temperature gradient along the length of the kiln. At a temperature of approximately 1400°−1500° C., the limestone will decompose into calcium oxide (CaO) and carbon dioxide (CO₂). Subsequent reactions sinter (i.e. fuse together without liquefying) the material in the kiln into clinker, which can then be ground to create Portland cement.

By mass, limestone is approximately 50% carbon dioxide, thus a significant amount of carbon dioxide is released during the formation of clinker.

Numerous strategies have been pursued to address the significant greenhouse gas (GHG) emissions from cement production. For example, during the hydration of Portland cement, calcium hydroxide (Ca(OH)₂) is produced. Calcium hydroxide has been identified as a possible source of carbonation (capturing carbon dioxide), therefore reversing calcination (releasing CO₂). Other proposed strategies for mitigating GHG emission from cement production involve the use of supplementary cementing materials (SCMs) and aggregates that have been treated with CO₂ to offset the emission intensity of the cement production. Further, as a technique for addressing the GHG emission from cement production, the most costly and robust process is post-combustion capture of the outlet gas of the kiln, typically using a scrubber system (e.g. an amine-based scrubber system) that produces a compressed CO₂ gas stream that must typically be transported for storage.

Another category of cement is made up of magnesium-based cements. There are two main types of magnesium-based cement: magnesium oxychloride (MOC) and magnesium oxysulfate (MOS). Magnesium oxychloride cements (MOC's) are an alternative to conventional Portland cement. MOC's are formed from the reaction of magnesium oxide (MgO) and magnesium chloride (MgCl₂). Mixing magnesium oxide, magnesium chloride, and water in a 5:1:12 ratio (i.e. 5 parts magnesium oxide to 1 part magnesium chloride to 12 parts water) and allowing it to cure creates ‘phase 5 MOC’, with the formula 5Mg(OH)₂·MgCl₂·8H₂O. Phase 5 MOC has a microscopic needle structure. The microscopic needle structure gives phase 5 MOC a high degree of structural integrity. Magnesium oxysulfate (MOS) is the sulfate analogue of MOC, wherein magnesium oxide, magnesium sulfate and water are mixed in a particular ratio to produce MOS cement. A third, less-explored magnesium carbonate-based cement has been briefly investigated and largely abandoned due to issues around the stability of the overall cementing phase.

Magnesium oxide is a required constituent of magnesium-based cement. Currently, magnesium oxide is predominantly synthesized via a process referred to as ‘the dry process’. The dry process entails mining magnesite (MgCO₃), and calcining it at a temperature of 650°−950° C. Calcination of magnesite produces magnesium oxide (MgO) and carbon dioxide. A state-of-the-art dry process produces on the order of 1.1kgCO₂ per kgMgO (1.1kgCO₂ eq).

Magnesium oxide can also be synthesized via a process referred to as ‘the wet process’. The wet process entails precipitating magnesium hydroxide (Mg(OH)₂) from magnesium bearing waters, and heating the magnesium hydroxide at a temperature of approximately 350° C. to create magnesium oxide and water. Typically, calcium hydroxide (Ca(OH)₂) or sodium hydroxide (NaOH) are used to precipitate the magnesium hydroxide, which results in a relatively high cost and relatively large carbon footprint, when factoring in the energy requirements for drying the product.

Both processes for obtaining magnesium oxide, the dry process and the wet process, are highly carbon intensive.

Consequently, there remains a desire to reduce the carbon intensity of producing cement and to thereby ameliorate the greenhouse gas contributions of the cement industry.

There is also a general need to make use of waste streams from existing industrial processes.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a method of producing cement. The method comprises: obtaining a first hydroxide; forming a first carbonate from the first hydroxide; forming a mixture by mixing the first carbonate, magnesium oxide and zeolite; and allowing the mixture to cure to thereby form cement.

Forming a mixture by mixing the first carbonate, magnesium oxide and zeolite may comprise forming the mixture by mixing the first carbonate, magnesium oxide, zeolite and a first brine.

The method may comprise obtaining the first brine from a waste stream of an industrial process.

Obtaining the first hydroxide may comprise electrolyzing a second brine.

The method may comprise obtaining the second brine from a waste stream of an industrial process.

Forming a mixture by mixing the first carbonate, magnesium oxide and zeolite may comprise forming the mixture by mixing the first carbonate, magnesium oxide, zeolite and a first brine. The first brine may be obtained from the waste stream of the industrial process.

The waste stream may comprise a waste stream from at least one of: production of oil and gas, production of potash, production of geothermal energy, and desalination.

The second brine may comprise a magnesium content of between approximately 10,000 ppm and 120,000 ppm.

The second brine may comprise a calcium content of between approximately 25,000 ppm to 125,000 ppm.

The second brine may comprise a sodium content of less than 150,000 ppm.

Forming a mixture by mixing the first carbonate, magnesium oxide and zeolite may comprise forming the mixture by mixing the first carbonate, magnesium oxide, zeolite and a first brine. The first brine may comprise the same composition as the second brine.

Electrolyzing the second brine may comprise applying voltage to the second brine to cause calcium chloride in the second brine to form hydrochloric acid and calcium hydroxide. The first hydroxide may comprise the calcium hydroxide formed from electrolyzing the second brine.

Electrolyzing the second brine may comprise applying voltage to the second brine to cause magnesium chloride in the second brine to form hydrochloric acid and magnesium hydroxide. The first hydroxide may comprise the magnesium hydroxide formed from electrolyzing the second brine.

The method may comprise: obtaining a second hydroxide; and forming a second carbonate from the second hydroxide. Forming the mixture may comprise mixing the first carbonate, the second carbonate, magnesium oxide and zeolite.

The first hydroxide may comprise calcium hydroxide. The first carbonate may comprise calcium carbonate. The second hydroxide may comprise magnesium hydroxide. The second carbonate may comprise magnesium carbonate.

Forming the first carbonate from the first hydroxide may comprise feeding a gas and the first hydroxide into a carbonation reactor. The gas may comprise greater than 5% carbon dioxide (by volume).

Forming the first carbonate from the first hydroxide may comprise feeding a gas and the first hydroxide into a carbonation reactor. The gas may comprise greater than 10% carbon dioxide (by volume).

Forming the first carbonate from the first hydroxide may comprise feeding a gas and the first hydroxide into a carbonation reactor. The gas may comprise between approximately 10% and 20% carbon dioxide (by volume).

The gas may be obtained by treating flue gas from at least one of: an industrial process and a power generation process.

The gas may be obtained by treating flue gas from the synthesis of magnesium oxide.

The flue gas may have a carbon dioxide content of between approximately 400 ppm and 150,000 ppm by concentration.

Treating the flue gas may comprise: separating carbon dioxide from the flue gas; and mixing the separated carbon dioxide with air to form the gas.

Treating the flue gas may comprise: removing water vapor from the flue gas before separating carbon dioxide from the flue gas.

Treating the flue gas may comprise: cooling the flue gas before separating carbon dioxide from the flue gas.

Separating carbon dioxide from the flue gas may comprise adsorbing the carbon dioxide with zeolite.

Mixing the separated carbon dioxide with air to form the gas may comprise releasing the adsorbed carbon dioxide from the zeolite into the air to form the gas.

Releasing the adsorbed carbon dioxide into the air to form the gas may comprise heating the zeolite and the adsorbed carbon dioxide to release the adsorbed carbon dioxide into the air.

The carbonation reactor may comprise a rotating packed bed reactor.

The method may comprise dewatering the mixture prior to curing to remove dissolved ions from the mixture.

The first hydroxide may comprise a carbonate-forming metal hydroxide.

The first hydroxide may comprise calcium hydroxide and the first carbonate may comprise calcium carbonate.

The first hydroxide may comprise magnesium hydroxide and the first carbonate may comprise magnesium carbonate.

Other aspects of the invention comprise methods, apparatus and kits comprising any features, combinations of features and/or sub-combinations of features described herein or inferable therefrom.

It is emphasized that the invention relates to all combinations and sub-combinations of the above features and other features described herein, even if these are recited in different claims or claims with different dependencies.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a flowchart depicting a method of forming magnesium-based cement according to the prior art.

FIG. 2 is a flowchart depicting a method of forming magnesium-based cement according to an example embodiment of this invention.

FIG. 3 is a flowchart depicting a system of forming magnesium-based cement according to an example embodiment of this invention.

FIG. 4 is a flowchart depicting a method of forming CO₂ enriched gas according to an example embodiment of this invention.

FIG. 5 is a flowchart depicting a system of forming CO₂ enriched gas according to an example embodiment of this invention.

FIG. 6 is a flowchart depicting a method of forming hydroxides according to an example embodiment of this invention.

FIG. 7 is a flowchart depicting a system of forming hydroxides according to an example embodiment of this invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

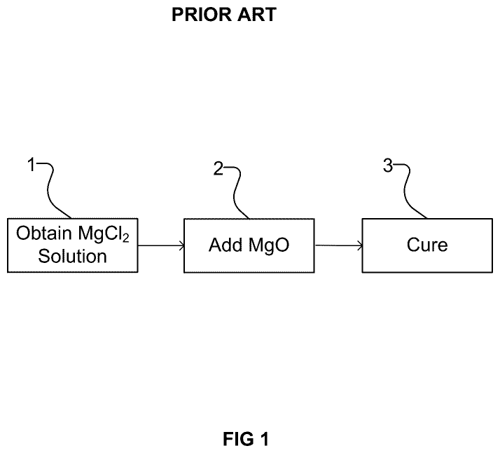

FIG. 1 depicts a method of forming magnesium-based cement (specifically, MOC) according to prior art techniques. Step 1 comprises acquiring a concentrated solution containing magnesium chloride. Magnesium chloride is an ingredient involved in the creation of MOC cement. Water is also an ingredient for MOC cement, hence the aqueous solution of magnesium chloride. Step 2 comprises adding magnesium oxide to the magnesium chloride solution. Given the expense associated with acquiring magnesium oxide, magnesium oxide is preferably added in a stoichiometric ratio to the magnesium chloride and water to limit the amount of unreacted magnesium oxide. As mentioned above, for a phase 5 MOC (which is the phase of MOC cement with a high level of structural integrity), the stoichiometric ratio is 5 parts magnesium oxide to 1 part magnesium chloride to 12 parts water. The mixture from step 2 is then allowed to cure in step 3. The mixture will initially have a slurry-like consistency, but upon curing it will solidify. Curing can take up to 7 days, though the curing time is variable and is a function of at least (but not limited to): temperature, humidity, and shape of the cured mixture (for example, curing the mixture in a cube shaped container will result in a faster curing time than curing the mixture in a spherical container due to a cube's higher surface area to volume ratio).

There are at least two disadvantages associated with the prior art method of forming cement shown in FIG. 1. A first disadvantage is associated with obtaining a magnesium chloride solution. Ideally, the magnesium chloride solution obtained in step 1 should have as high a purity of magnesium chloride as possible. Impurities (such as calcium ions) reduce the effectiveness of the curing step 3, as such impurities will limit the extent of reaction between magnesium oxide, magnesium chloride, and water. The calcium in solution does not form a 5 MOC structure (or calcium analog) and inhibits the growth of structurally strong cements. A second disadvantage of the FIG. 1 cement formation technique is associated with the carbon intensity of forming magnesium oxide. As mentioned above, production of magnesium oxide is a highly carbon dioxide intensive process, and the FIG. 1 method does not ameliorate the carbon intensity of producing cement.

Though the flowchart in FIG. 1 shows the procedure for making magnesium oxychloride cement (MOC), an analogous procedure can be followed for making other types of magnesium-based cement. For example, if the ion in solution was magnesium sulfate rather than magnesium chloride, then magnesium oxysulfate (MOS) would form. As mentioned above, magnesium oxysulfate (MOS) is another type of magnesium-based cement.

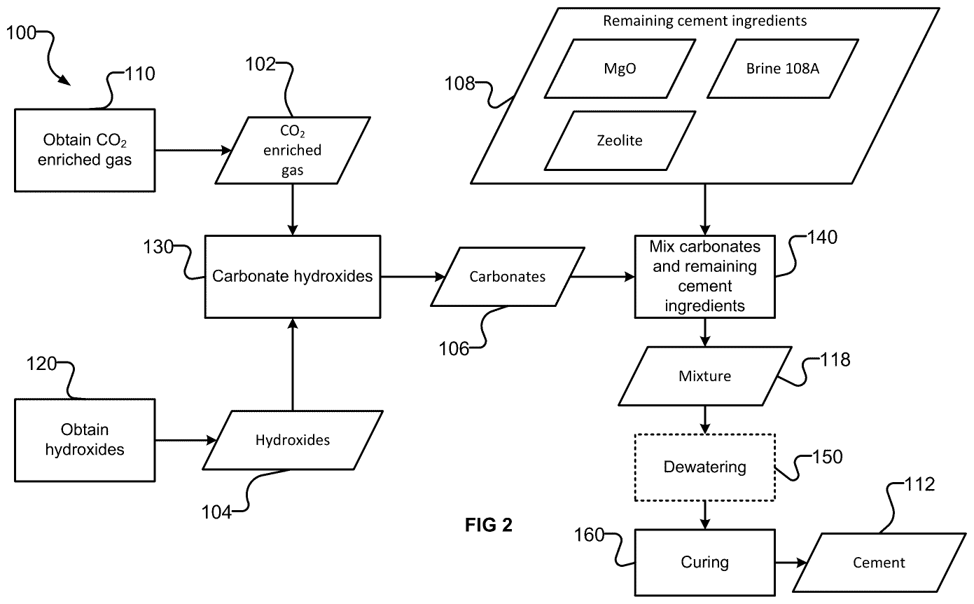

One aspect of the invention provides a method for forming cement. FIG. 2 depicts a method 100 for forming cement 112 according to an example embodiment of the invention.

Step 110 comprises obtaining a CO₂ enriched gas 102 (also referred to simply as gas 102). Gas 102 may be obtained from any suitable source and by any suitable process. In some embodiments, gas 102 is obtained by method 200, described further herein.

Gas 102 may comprise between approximately 5% CO₂ (by volume) and approximately 100% CO₂ (by volume). Gas 102 may comprise between approximately 5% CO₂ (by volume) and approximately 20% CO₂ (by volume). Gas 102 may comprise between approximately 8% CO₂ (by volume) and approximately 12% CO₂ (by volume). Gas 102 may comprise approximately 10% CO₂ (by volume). In some embodiments, at least a portion of the remaining composition of gas 102 comprises air (e.g. a mixture of primarily nitrogen and oxygen). Gas 102 may comprise some water vapor. In some embodiments, gas 102 comprises less than 10% water vapor (by volume). In some embodiments, gas 102 comprises less than 0.01% water vapor (by volume). In some embodiments, gas 102 comprises less than 0.001% water vapor (by volume).

Since CO₂ enriched gas 102 may have a concentration of at least as low as approximately 20% CO₂ (by volume), step 110 may avoid the significant energy expenditures (and potential associated release of CO₂ from such energy expenditure) associated with other methods of carbon capture which require increasing the concentration of CO₂ enriched gas 102 (e.g. to concentrations above 20% CO₂ (by volume), above 50% CO₂ (by volume) and/or above 90% CO₂ (by volume)). Further, capital expenditures associated with building infrastructure for producing CO₂ enriched gas 102 obtained in step 110 may be reduced significantly (e.g. as compared to the cost of infrastructure used in other methods of carbon capture to achieve concentrations above 20% CO₂ (by volume), above 50% CO₂ (by volume) and/or above 90% CO₂ (by volume)). This reduction in capital expenditure in turn allows for onsite production of CO₂ enriched gas 102 (e.g. at the same site as where method 100 occurs), thereby also avoiding energy intensive transportation (and otherwise necessary energy intensive compression) of CO₂ enriched gas 102.

Step 120 comprises obtaining one or more hydroxides 104. Hydroxides 104 may be obtained from any suitable source and by any suitable process. In some embodiments, hydroxides 104 are obtained by method 300, described further herein.

Hydroxides 104 may comprise any suitable hydroxides or anions that react to form a chemical bond with CO₂. Hydroxides 104 may comprise carbonate-forming metal hydroxides. For example, hydroxides 104 may comprise calcium hydroxide (Ca(OH)₂), sodium hydroxide (NaOH), magnesium hydroxide (Mg(OH)₂) and/or other metal hydroxides. Hydroxides 104 may comprise an aqueous solution of hydroxides. For example, hydroxides 104 may comprise between approximately 80% and 90% water (by volume). Hydroxides 104 may comprise an aqueous solution of hydroxides with pH greater than or equal to approximately 10.

Step 130 comprises carbonating hydroxides 104 to form carbonates 106. Carbonating hydroxides 104 may comprise reacting hydroxides 104 and gas 102 to form carbonates 106.

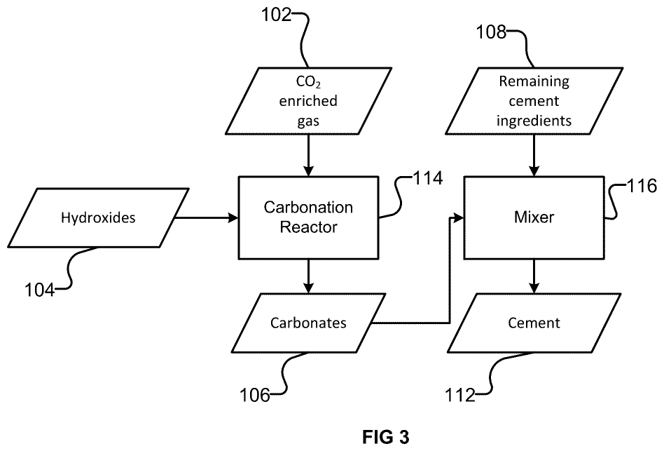

Carbonation at step 130 may occur in a carbonation reactor 114 (see FIG. 3). Carbonation reactor 114 may comprise any suitable carbonation reactor. For example, carbonation reactor 114 may comprise a rotating packed bed reactor, a micro bubble reactor, any gas-injecting or gas-tight mixer and/or the like. Carbonation reactor 114 may comprises a microbubble generator to cycle gas 102 through carbonation reactor 114.

Gas 102 may be cycled through carbonation reactor 114 until sufficient conversion of hydroxides 104 to carbonates 106 has occurred. For example, gas 102 may be cycled through carbonation reactor 114 until conversion of approximately 75% or more of hydroxides 104 to carbonates 106 has occurred or until conversion of approximately 90% or more of hydroxides 104 to carbonates 106 has occurred.

Where hydroxides 104 comprise Ca(OH)₂, carbonation at step 130 may comprise the formation of a calcium carbonate (CaCO₃) carbonate 106 and water as follows:

Ca(OH)₂+CO₂→CaCO₃+H₂O

Where hydroxides 104 additionally or alternatively comprise Mg(OH)₂, carbonation at step 30 may comprise the formation of a magnesium carbonate (MgCO₃) carbonate 106 and water as follows:

Mg(OH)₂+CO₂→MgCO₃+H₂O

As hydroxides 104 may be an aqueous solution and/or the carbonation reactions may form water, carbonates 106 may be an aqueous solution. For example, carbonates 106 may comprise between approximately 80% and 90% water (by volume).

Step 140 comprises mixing carbonates 106 with remaining cement ingredients 108. Remaining cement ingredients 108 may comprise, for example, magnesium oxide (MgO), additional brine 108A, zeolite (or a zeolite replacement such as, but not limited to, PozGlass™) and/or supplementary cementing materials (such as, but not limited to, PozGlass™) to form a mixture 118. The inclusion of additional brine 108A at step 140 may assist the cementing process through the formation of magnesium oxychloride and/or magnesium oxysulfate. In some embodiments, remaining cement ingredients 108 do not include additional brine 108A (e.g. where the cementing reaction is predominantly the carbonation of MgO and subsequent dewatering). Some water may be released (e.g. evaporate) from mixture 118 during step 140.

Brine 108A is preferably sourced from an industrial process. Ideally brine 108A is a waste stream from the production of oil and gas, potash, desalination, geothermal energy and/or the like. Oil and gas, potash, desalination and geothermal energy production all produce brines with high magnesium concentrations (in excess of 10,000 ppm), and high calcium concentrations (in excess of 50,000 ppm). These and other industrial waste streams typically contain high amounts of magnesium and calcium.

The magnesium content of the waste stream that makes up brine 108A may be in a range between approximately 10,000 ppm and 120,000 ppm and, in some embodiments, in a range between approximately 50,000 ppm and 75,000 ppm. The calcium content of the waste stream that makes up brine 108A may be in a range between approximately 25,000 ppm to 125,000 ppm and, in some embodiments, in a range between approximately 25,000 ppm and 50,000 ppm. In some embodiments, the sodium content of the waste stream that makes up brine 108A may be less than 150,000 ppm and, in some embodiments, less than 10,000 ppm. There may be some sulfate ions in the waste stream. If this is the case (i.e. sulphate ions are present), then during the curing step (discussed further herein), some magnesium oxysulfate will form.

Mixing carbonates 106 with remaining cement ingredients 108 at step 140 may occur with the aid of any suitable mixing device 116 (see FIG. 3). For example, in some embodiments, mixing device 116 comprises a cement mixer.

Step 150 is an optional step that comprises dewatering mixture. 118 Dewatering may serve a number of purposes.

One purpose of the optional step 150 dewatering process may be to remove dissolved ions from mixture 118. As mentioned before, brine 108A may contain ions such as (but not limited to) sodium, potassium, or iron. These ions do not normally form part of the binding phase of magnesium-based cements. Furthermore, these ions will not precipitate out of solution to the same extent as calcium carbonate (e.g. due to the low solubility of calcium carbonate). As such, it may be desirable to remove some of the water from the mixture prior to curing in step 160. Removing some of the water may reduce the total amount of dissolved ions in the curing step, but the concentration of dissolved ions in solution may remain the same.

Another purpose for optional step 150 dewatering process may be to adjust the ratio of magnesium oxide, magnesium chloride, and water in mixture 118. As mentioned before, the constituents of MOC cement are ideally mixed in a ratio of 5 parts magnesium oxide to 1 part magnesium chloride to 12 parts water, as this will form a phase of MOC cement that has high strength. Too much water may cause less desirable MOC cement phases to form. These are non-exhaustive purposes for dewatering in optional step 150; there may be other purposes for the optional dewatering step 150.

Step 160 comprises curing mixture 118 to form cement 112. The time spent curing is a function of at least temperature, humidity, and the shape of the curing vessel. In some implementations, curing in step 160 may take time in a range of 72 hours to 7 days. In some implementations, curing in step 160 is performed at a temperature in a range of approximately 20° to 50° C., with currently preferred temperatures in a range of approximately 20° to 30° C. During the step 160 curing process, humidity may be maintained relatively high (e.g. above 90%) for a first period of time (e.g. 18-30 hours) and the humidity may be decreased (e.g. to levels in a range of 50%-80% or to levels of 50%-60%) from 30 hours onward for the remainder of the step 160 curing process.

As mixture 118 cures to form cement 112, carbonates 106 remain entrained in cement 112, thereby sequestering CO₂ from CO₂ enriched gas 102 in cement 112. While some CO₂ may be released when forming MgO employed at step 140 and/or some CO₂ may be released as mixture 118 cures to form cement 112 (e.g. from limestone decomposing into calcium oxide (CaO) and CO₂), the amount of CO₂ released from forming MgO employed at step 140 and released across steps 140 to 160 may be less than the amount of CO₂ sequestered from CO₂ enriched gas 102 in cement 112 such that cement 112 produced by method 100 may be carbon negative (e.g. method 100 may sequester more CO₂ than it produces/releases).

During or after step 160, cement 112 may be pressed or extruded into desired shapes for building applications (e.g. precast building applications) such as, for example, siding, floor tiles, wall tiles, etc.

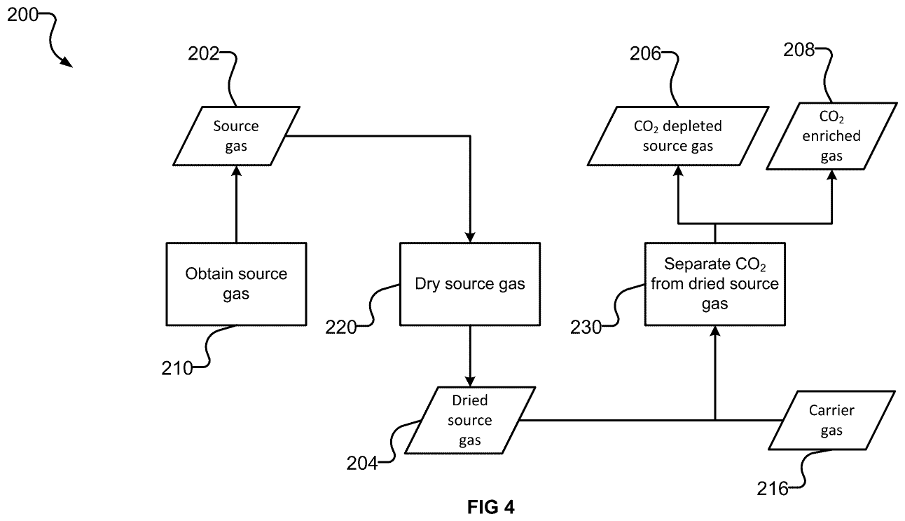

One aspect of the invention provides a method of obtaining CO₂ enriched gas. FIG. 4 depicts a method 200 of obtaining CO₂ enriched gas 208 according to an example embodiment of the invention. Method 200 may be employed, for example, in block 110 of method 100.

Step 210 comprises obtaining source gas 202. Source gas 202 could be from a number of sources. For example, source gas 202 could be ambient air, flue gas, compressed air and/or an emission source from an industrial process. Source gas 202 may contain carbon dioxide at a concentration of between approximately 400 ppm and 120,000 ppm. Beyond the desirability that there be carbon dioxide, source gas 202 could have any composition and have a wide array of process stream characteristics. For example, source gas 202 could have high particulate contents, and it could also be at high pressure or temperature. Source gas 202 may contain moisture, oxygen, nitrous oxides, sulfur oxides and/or particulate matter that may either remain entrapped in the final cement mixture (e.g. in the case where method 200 is used in block 110 of method 100) or be passed through the reaction mixture. Source gas 202 may comprise between approximately 0.25% and 1% water vapor (by volume). Source gas 202 may comprise approximately 0.5% water vapor (by volume).

Source gas 202 may comprise flue gas from the production of magnesium oxide. As mentioned above, the production of magnesium oxide releases substantial amounts of carbon dioxide. Using flue gas from the production of magnesium oxide would be particularly advantageous, as the carbon dioxide created during the production of magnesium oxide could be captured during cement formation method 100.

Step 220 comprises drying source gas 202 to form dried source gas 204. Step 220 may comprise removing water vapor from source gas 202 to form dried source gas 204. Where source gas 202 already has sufficiently low water vapor content, step 220 may be skipped and source gas 202 may be employed in place of dried source gas 204.

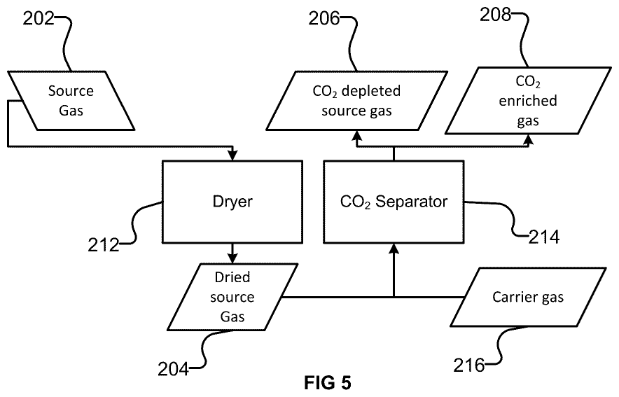

Source gas 202 may be dried at step 220 with any suitable dryer 212 (see FIG. 5). Dryer 212 may comprise a deliquescent dyer, a desiccant dryer, a membrane dryer, a chiller, a refrigerant dryer, etc. For example, dryer 212 may comprises one or more drying columns packed with one or more microsieves or drying agents (e.g. silica) to absorb and/or adsorb water.

At step 220, water vapor in source gas 202 may be reduced to less than approximately less than 0.01% water vapor (by volume). In some embodiments, gas water vapor in source gas 202 is reduced to less than approximately 0.001% water vapor (by volume).

In some embodiments, source gas 202 is provided at step 220 at a temperature of less than 25° C. Source gas 202 may be provided to step 220 at a temperature of less than 15° C. or even less than 0° C.

At step 230, at least a portion of the CO₂ content of dried source gas 204 is separated from dried source gas 204 to form a CO₂ enriched gas 208. A by-product of step 230 may be a CO₂ depleted source gas 206 (e.g. depleted source gas 206 comprises the remaining content of dried source gas 204 after at least some of the CO₂ content was separated therefrom).

Any suitable CO₂ separator 214 (see FIG. 5) may be employed at step 230. For example CO₂ separator 214 may comprise a functionalized membrane, or a liquid based spray system containing high affinity CO₂ solutions such as amines, hydroxides, etc. CO₂ separator 214 may employ a solid sorbent material such as, zeolite (e.g. 4A zeolite 13X), activated carbon, or other CO₂ selective material.

In some embodiments, step 230 occurs in two stages: adsorption of CO₂ and desorption of CO₂. In some embodiments, a CO₂ separator 214 adsorbs CO₂ from dried source gas 206 during a first phase and may then release (e.g. desorb) the adsorbed CO₂ as desired during a second phase. In some embodiments, the second phase is initiated by heating, and/or reducing the pressure within, CO₂ separator 214.

In some embodiments, CO₂ separator 214 comprises zeolite (e.g. zeolite 13X) which may adsorb CO₂ when at a first temperature and release CO₂ when at a second temperature. For example, dried source gas 204 may be directed into CO₂ separator 214 at the first temperature. Then, after sufficient CO₂ is adsorbed, the remaining CO₂ depleted gas 206 may be released from CO₂ separator 214. The adsorbed CO₂ may then be desorbed to form CO₂ enriched gas 208 by raising the temperature of CO₂ separator 214 to the second temperature. In some embodiments, the first temperature is less than 20° C. In some embodiments, the first temperature is less than 5° C. In some embodiments, the second temperature is between approximately 50° C. and 120° C. In some embodiments, the second temperature is more than 70° C. In some embodiments, the second temperature is approximately 90° C.

To facilitate removing desorbed CO₂ from CO₂ separator 214 during the second phase and transporting the CO₂ to the next step, a carrier gas 216 may be flushed through CO₂ separator 214. The resultant CO₂ enriched gas 208 may therefore comprises a mixture of CO₂ and carrier gas 216. Carrier gas 216 may comprise air (e.g. a mixture of primarily nitrogen and oxygen).

CO₂ enriched gas 208 may comprise between approximately 5% CO₂ (by volume) and approximately 100% CO₂ (by volume). CO₂ enriched gas 208 may comprise between approximately 5% CO₂ (by volume) and approximately 20% CO₂ (by volume). CO₂ enriched gas 208 may comprise between approximately 8% CO₂ (by volume) and approximately 12% CO₂ (by volume). CO₂ enriched gas 208 may comprise approximately 10% CO₂ (by volume).

The CO₂ enriched gas 208 formed by method 200 may be employed as gas 102 for method 100, although this is not mandatory. In some embodiments, CO₂ enriched gas 208 is stored for later usage (e.g. in method 100). In some embodiments, CO₂ enriched gas 208 flows directly to carbonation reactor 114 for use at step 130 of method 100.

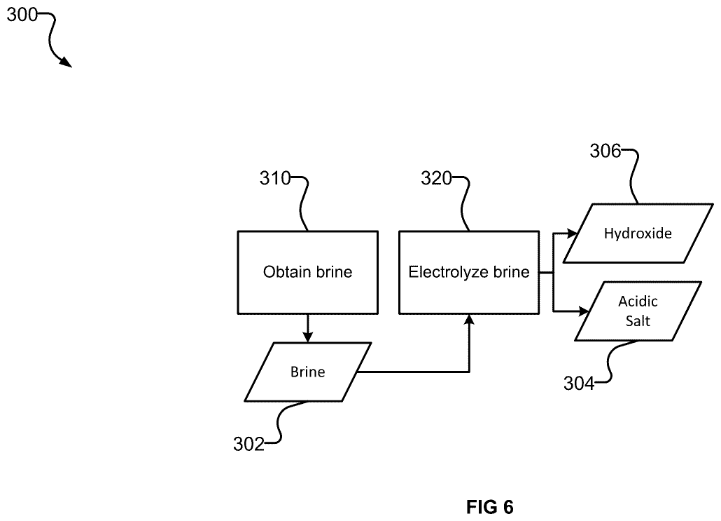

One aspect of the invention provides a method of obtaining hydroxides from a brine. FIG. 6 depicts a method 300 of obtaining hydroxides 306 from a brine 302 according to an example embodiment of the invention. Method 300 may be employed, for example, in block 120 of method 100.

Step 310 comprises obtaining brine 302. Brine 302 is preferably sourced from an industrial process. Ideally brine 302 is a waste stream from the production of oil and gas, potash, desalination, geothermal energy and/or the like. Oil and gas, potash, desalination and geothermal energy production all produce brines with high magnesium concentrations (in excess of 10,000 ppm), and high calcium concentrations (in excess of 50,000 ppm). These and other industrial waste streams typically contain high amounts of magnesium and calcium.

The magnesium content of the waste stream that makes up brine 302 may be in a range between approximately 10,000 ppm and 120,000 ppm and, in some embodiments, between approximately 50,000 ppm and 75,000 ppm. The calcium content of the waste stream that makes up brine 302 may be in a range between approximately 25,000 ppm to 125,000 ppm and, in some embodiments, between approximately 25,000 ppm and 50,000 ppm. In some embodiments, the sodium content of the waste stream that makes up brine 302 may be less than 150,000 ppm and, in some embodiments, less than 10,000 ppm. There may be some sulfate ions in the waste stream. If this is the case (i.e. sulphate ions are present), then during the curing step 160 (where method 300 is used in block 120 of method 100), some magnesium oxysulfate will form.

Step 320 comprises electrolyzing brine 302 to form one or more hydroxides 306 and one or more acidic salts 304. Hydroxides 306 may comprise, for example, carbonate-forming metal hydroxides. For example, where brine 302 comprises water and calcium chloride (CaCl₂)), electrolysis of brine 302 may first form hydrogen ions and hydroxide ions. The hydroxide ions and hydrogen ions may then react with the CaCl₂) to form calcium hydroxide (Ca(OH)₂) as hydroxide 306 and hydrochloric acid (HCl) as acidic salt 304, as follows:

H₂O→H⁺+OH⁻

CaCl₂+2H⁺+2OH⁻→2HCl+Ca(OH)₂

As another example, where brine 302 alternatively or additionally comprises water and magnesium chloride (MgCl₂), electrolysis of brine 302 may first form hydrogen ions and hydroxide ions. The and hydroxide ions and hydrogen ions may then react with the MgCl₂ to form magnesium hydroxide (Mg(OH)₂) as hydroxide 306 and hydrochloric acid (HCl) as acidic salt 304, as follows:

H₂O→H⁺+OH⁻

MgCl₂+2H⁺+2OH⁻→2HCl+Mg(OH)₂

Hydroxides 306 produced at step 320 may be an aqueous solution with a ratio of solids to liquid of between approximately 0.01 to 0.5 (by volume). Hydroxides 306 produced at step 320 may be an aqueous solution with a ratio of solids to liquid of approximately 0.5 (by volume).

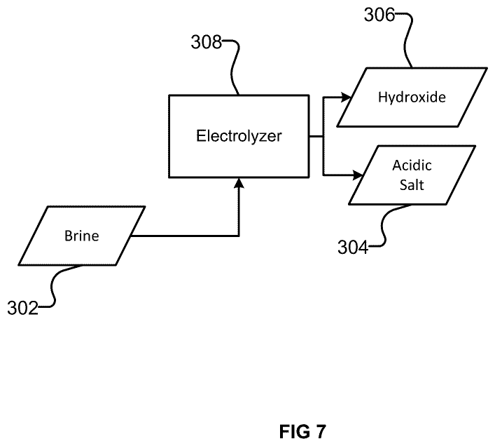

Step 320 may employ any suitable electrolyzer 308 (see FIG. 7). Electrolyzer 308 may or may not employ one or more membranes (e.g. to separate hydroxides 306 from acidic salts 304). Electrolyzer 308 may be a continuous flow electrolyzer. In some embodiments, electrolyzer 308 comprises a continuous flow membraneless cell.

Electrolyzer 308 may comprise an anode and a cathode. For example, electrolyzer 308 may comprise membrane anodes and cathodes to separate hydroxides 306 from acidic salts 304 as they are formed. In some embodiments, electrolyzer 308 comprises an anode of stainless steel iron, graphite carbon, etc. In some embodiments, electrolyzer 308 comprises a cathode of platinum, graphite, titanium or another conductive material suitable for a hydrogen evolution reaction.

Electrolyzer 308 may apply a voltage to brine 302 (e.g. by applying a voltage across an anode and a cathode inserted at least partially into brine 302). The voltage may be between approximately 0.1V and 10V. The voltage may be between approximately 0.5V and 5V. The voltage applied to brine 302 at step 320 may be chosen to: (1) achieve desired pH levels of hydroxides 306 and acidic salts 304; and/or (2) minimize energy costs associated with step 320. To achieve these goals, the voltage may be increased if the difference in pH between hydroxides 306 and acidic salts 304 is less than seven; the voltage may be decreased if the difference in pH between hydroxides 306 and acidic salts 304 is more than 10; the voltage may be increased if the pH of hydroxides 306 is three or more and/or the pH of acidic salts 304 is 10 or less; and/or the voltage may be decreased if the pH of hydroxides 306 is three or less and/or the pH of acidic salts 304 is 10 or more. These changes in voltage may be effected by a suitably configured controller/processor (not shown) connected to receive signals from pH sensors (not shown) and to a apply voltage signal between the anode and cathode.

The one or more hydroxides 306 formed by method 300 may be employed as hydroxides 104 for method 100, although this is not mandatory. In some embodiments, hydroxides 306 are stored for later usage (e.g. in method 100). In some embodiments, hydroxides 306 flow directly to carbonation reactor 114 for use at step 130 of method 100.

In some embodiments, method 100 is combined with one or both of method 200 and method 300 for carbon sequestration through making of magnesium-based cement. The combined method may allow for carbon negative manufacturing of magnesium-based cement with relatively low energy requirements compared to traditional techniques for making magnesium-based cement (e.g. since relatively low concentration CO₂ enriched gas 102 may be employed rather than high concentration CO₂ enriched gas 102 which could require energy intensive purification, compression and/or transportation from an offsite plant). The combined method may allow for carbon negative manufacturing of magnesium-based cement with relatively lower capital cost requirements compared to traditional techniques for making magnesium-based cement (e.g. due to a lack of need of equipment for achieving high concentration CO₂ enriched gas 102).

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

While processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Where a component is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

The invention comprises a number of non-limiting aspects. Non-limiting aspects of the invention include:
1. A method of producing cement, the method comprising:
   obtaining a first hydroxide by electrolyzing a first brine;
   forming a first carbonate from the first hydroxide;
   forming a mixture by mixing the first carbonate, magnesium oxide and zeolite; and
   allowing the mixture to cure to thereby form cement.
2. A method according to aspect 1 or any other aspect herein wherein forming a mixture by mixing the first carbonate, magnesium oxide and zeolite comprises forming the mixture by mixing the first carbonate, magnesium oxide, zeolite and a second brine.
3. A method according to aspect 2 or any other aspect herein comprising obtaining the second brine from a waste stream of an industrial process.
4. A method according to aspect 1 or any other aspect herein comprising obtaining the first brine from a waste stream of an industrial process.
5. A method according to aspect 1 or any other aspect herein wherein:
   forming a mixture by mixing the first carbonate, magnesium oxide and zeolite comprises forming the mixture by mixing the first carbonate, magnesium oxide, zeolite and a second brine; and
   the second brine is obtained from the waste stream of the industrial process.
6. A method according to any one of aspects 4 and 5 or any other aspect herein wherein the waste stream comprises a waste stream from at least one of: production of oil and gas, production of potash, production of geothermal energy, and desalination.
7. A method according to any one of aspects 1 to 6 or any other aspect herein wherein the first brine comprises a magnesium content of between approximately 10,000 ppm and 120,000 ppm.
8. A method according to any one of aspects 1 to 7 or any other aspect herein wherein the first brine comprises a calcium content of between approximately 25,000 ppm to 125,000 ppm.
9. A method according to any one of aspects 1 to 8 or any other aspect herein wherein the first brine comprises a sodium content of less than 150,000 ppm.
10. A method according to any one of aspects 1, 4 and 6 to 9 or any other aspect herein wherein:
   forming a mixture by mixing the first carbonate, magnesium oxide and zeolite comprises forming the mixture by mixing the first carbonate, magnesium oxide, zeolite and a second brine; and
   the second brine comprises the same composition as the first brine.
11. A method according to any one of aspects 1, 4 and 6 to 10 or any other aspect herein wherein electrolyzing the first brine comprises applying voltage to the first brine to cause calcium chloride in the first brine to form hydrochloric acid and calcium hydroxide and the first hydroxide comprises the calcium hydroxide formed from electrolyzing the first brine.
12. A method according to any one of aspects 1, 4 and 6 to 10 or any other aspect herein wherein electrolyzing the first brine comprises applying voltage to the first brine to cause magnesium chloride in the first brine to form hydrochloric acid and magnesium hydroxide and the first hydroxide comprises the magnesium hydroxide formed from electrolyzing the first brine.
13. A method according to any one of aspects 1 to 12 or any other aspect herein comprising:
   obtaining a second hydroxide;
   forming a second carbonate from the second hydroxide; and wherein:
   forming the mixture comprises mixing the first carbonate, the second carbonate, magnesium oxide and zeolite.
14. A method according to aspect 13 or any other aspect herein wherein the first hydroxide comprises calcium hydroxide and the first carbonate comprises calcium carbonate and wherein the second hydroxide comprises magnesium hydroxide and the second carbonate comprises magnesium carbonate.
15. A method according to any one of aspects 1 to 13 or any other aspect herein wherein forming the first carbonate from the first hydroxide comprises feeding a gas and the first hydroxide into a carbonation reactor, wherein the gas comprises greater than 5% carbon dioxide (by volume).
16. A method according to any one of aspects 1 to 13 or any other aspect herein wherein forming the first carbonate from the first hydroxide comprises feeding a gas and the first hydroxide into a carbonation reactor, wherein the gas comprises greater than 10% carbon dioxide (by volume).
17. A method according to any one of aspects 1 to 13 or any other aspect herein wherein forming the first carbonate from the first hydroxide comprises feeding a gas and the first hydroxide into a carbonation reactor, wherein the gas comprises between approximately 10% and 20% carbon dioxide (by volume).
18. A method according to any one of aspects 15 to 17 or any other aspect herein wherein the gas is obtained by treating flue gas from at least one of: an industrial process and a power generation process.
19. A method according to any one of aspects 15 to 17 or any other aspect herein wherein the gas is obtained by treating flue gas from the synthesis of magnesium oxide.
20. A method according to any one of aspects 18 to 19 or any other aspect herein wherein the flue gas has a carbon dioxide content of between approximately 400 ppm and 150,000 ppm by concentration.
21. A method according to any one of aspects 18 to 20 or any other aspect herein wherein treating the flue gas comprises:
   separating carbon dioxide from the flue gas; and
   mixing the separated carbon dioxide with air to form the gas.
22. A method according to aspect 21 or any other aspect herein wherein treating the flue gas comprises:
   removing water vapor from the flue gas before separating carbon dioxide from the flue gas.
23. A method according to any one of aspects 21 and 22 or any other aspect herein wherein treating flue gas comprises:
   cooling the flue gas before separating carbon dioxide from the flue gas.
24. A method according to any one of aspects 21 to 23 or any other aspect herein wherein separating carbon dioxide from the flue gas comprises adsorbing the carbon dioxide with zeolite.
25. A method according to aspect 24 or any other aspect herein wherein mixing the separated carbon dioxide with air to form the gas comprises releasing the adsorbed carbon dioxide from the zeolite into the air to form the gas.
26. A method according to aspect 25 or any other aspect herein wherein releasing the adsorbed carbon dioxide into the air to form the gas comprising heating the zeolite and the adsorbed carbon dioxide to release the adsorbed carbon dioxide into the air.
27. A method according to any one of aspects 15 to 17 or any other aspect herein wherein the carbonation reactor comprises a rotating packed bed reactor.
28. A method according to any one of aspects 1 to 27 or any other aspect herein comprising dewatering the mixture prior to curing to remove dissolved ions from the mixture.
29. A method according to any one of aspects 1 to 28 or any other aspect herein wherein the first hydroxide comprises a carbonate-forming metal hydroxide.
30. A method according to any one of aspects 1 to 28 or any other aspect herein wherein the first hydroxide comprises calcium hydroxide and the first carbonate comprises calcium carbonate.
31. A method according to any one of aspects 1 to 28 or any other aspect herein wherein the first hydroxide comprises magnesium hydroxide and the first carbonate comprises magnesium carbonate.
32. Methods comprising any features, combinations of features and/or sub-combinations of features described herein or inferable therefrom.
33. Apparatus comprising any features, combinations of features and/or sub-combinations of features described herein or inferable therefrom.
34. Kits comprising any features, combinations of features and/or sub-combinations of features described herein or inferable therefrom.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1.-20. (canceled)

21. A method of producing cement, the method comprising:
obtaining a first hydroxide by electrolyzing a first brine;
forming a first carbonate from the first hydroxide;
forming a mixture by mixing the first carbonate, magnesium oxide and zeolite; and
allowing the mixture to cure to thereby form cement.

22. A method according to claim 21 wherein forming a mixture by mixing the first carbonate, magnesium oxide and zeolite comprises forming the mixture by mixing the first carbonate, magnesium oxide, zeolite and a second brine.

23. A method according to claim 22 comprising obtaining one or both of the first and the second brine from a waste stream of an industrial process.

24. The method of claim 23 wherein the first and second brine have the same composition.

25. A method according to claim 23 wherein the waste stream comprises a waste stream from at least one of: production of oil and gas, production of potash, production of geothermal energy, and desalination.

26. A method according to claim 21 wherein electrolyzing the first brine comprises applying voltage to the first brine to cause calcium chloride in the first brine to form hydrochloric acid and calcium hydroxide and the first hydroxide comprises the calcium hydroxide formed from electrolyzing the first brine.

27. A method according to claim 21 wherein electrolyzing the first brine comprises applying voltage to the first brine to cause magnesium chloride in the first brine to form hydrochloric acid and magnesium hydroxide and the first hydroxide comprises the magnesium hydroxide formed from electrolyzing the first brine.

28. A method according to claim 21 comprising:
obtaining a second hydroxide;
forming a second carbonate from the second hydroxide; and wherein:
forming the mixture comprises mixing the first carbonate, the second carbonate, magnesium oxide and zeolite.

29. A method according to claim 28 wherein the first hydroxide comprises calcium hydroxide and the first carbonate comprises calcium carbonate and wherein the second hydroxide comprises magnesium hydroxide and the second carbonate comprises magnesium carbonate.

30. A method according to claim 21 wherein forming the first carbonate from the first hydroxide comprises feeding a gas and the first hydroxide into a carbonation reactor, wherein the gas comprises greater than 5% carbon dioxide (by volume).

31. A method according to claim 30 wherein the gas is obtained by treating flue gas from at least one of: an industrial process and a power generation process.

32. A method according to claim 30 wherein the gas is obtained by treating flue gas from synthesis of magnesium oxide.

33. A method according to claim 31 wherein treating the flue gas comprises:
separating carbon dioxide from the flue gas; and
mixing the separated carbon dioxide with air to form the gas.

34. A method according to claim 33 wherein treating the flue gas further comprises:
removing water vapor from the flue gas before separating carbon dioxide from the flue gas.

35. A method according to claim 33 wherein treating flue gas further comprises:
cooling the flue gas before separating carbon dioxide from the flue gas.

36. A method according to any claim 33 wherein separating carbon dioxide from the flue gas comprises adsorbing the carbon dioxide with an adsorption zeolite.

37. A method according to claim 36 wherein mixing the separated carbon dioxide with air to form the gas comprises releasing the adsorbed carbon dioxide from the adsorption zeolite into the air to form the gas by heating the adsorption zeolite.

38. A method according to claim 31 wherein the carbonation reactor comprises a rotating packed bed reactor.

39. A method according to claim 21 comprising dewatering the mixture prior to curing to remove dissolved ions from the mixture.

40. A method according to claim 21 wherein the first hydroxide comprises a carbonate-forming metal hydroxide.
